(19) United States
(12) Patent Application Publication
(10) Pub. No.: US 2015/0278628 A1
(43) Pub. Date: Oct. 1, 2015

(54) INVARIANT OBJECT REPRESENTATION OF IMAGES USING SPIKING NEURAL NETWORKS

(71) Applicant: QUALCOMM Incorporated, San Diego, CA (US)

(72) Inventors: Pulkit AGRAWAL, Berkeley, CA (US); Somdeb MAJUMDAR, San Diego, CA (US); Vikram GUPTA, San Diego, CA (US)

(73) Assignee: QUALCOMM Incorporated, San Diego, CA (US)

(21) Appl. No.: 14/228,071

(22) Filed: Mar. 27, 2014

(51) Int. Cl. G06K 9/46; G06K 9/66

(52) U.S. Cl. CPC G06K 9/4647; G06K 9/66

(57) ABSTRACT

A method for generating a histogram in a spiking neural network includes counting spikes associated with a latency encoded representation of an object. The method also includes generating the histogram based on the spike count.

### BACKGROUND

1. Field

Certain aspects of the present disclosure generally relate to neural system engineering and, more particularly, to systems and methods for invariant object representation of images using spiking neural networks.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

### SUMMARY

In an aspect of the present disclosure, a method for generating a histogram in a spiking neural network is disclosed. The method includes counting spikes associated with a latency encoded representation of an object. The method further includes generating the histogram based on the spike count.

In another aspect of the present disclosure, an apparatus for generating a histogram in a spiking neural network is disclosed. The apparatus includes a memory and at least one processor coupled to the memory. The processor(s) is configured to count spikes associated with a latency encoded representation of an object. The processor(s) is further configured to generate the histogram based on the spike count.

In still another aspect, an apparatus for generating a histogram in a spiking neural network is disclosed. The apparatus includes means for counting spikes associated with a latency encoded representation of an object. The apparatus further includes means for generating the histogram based on the spike count.

In yet another aspect of the present disclosure, a computer program product is disclosed. The computer program product includes a non-transitory computer readable medium having encoded thereon program code. The program code includes program code to count spikes associated with a latency encoded representation of an object. The program code further includes program code to generate the histogram based on the spike count.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9 is a block diagram illustrating an exemplary network structure for invariant object representation in accordance with aspects of the present disclosure.

FIG. 10 is a block diagram illustrating exemplary circuitry of a spiking neural network for providing invariant object representation in accordance with aspects of the present disclosure.

FIG. 11 is a diagram illustrating an exemplary configuration of relay cells in accordance with aspects of the present disclosure.

FIGS. 12A-C illustrate orientations of an object in accordance with aspects of the present disclosure.

FIGS. 13A-B are diagrams illustrating an exemplary histogram layer in accordance with aspects of the present disclosure.

FIG. 14 is an exemplary diagram illustrating modulated potential of relay cells in accordance with aspects of the present disclosure.

FIG. 15 is a flow chart illustrating a method for invariant object representation of images using a spiking neural network in accordance with an aspect of the present disclosure.

FIG. 16 is a flow chart illustrating a method for generating a histogram using a spiking neural network in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

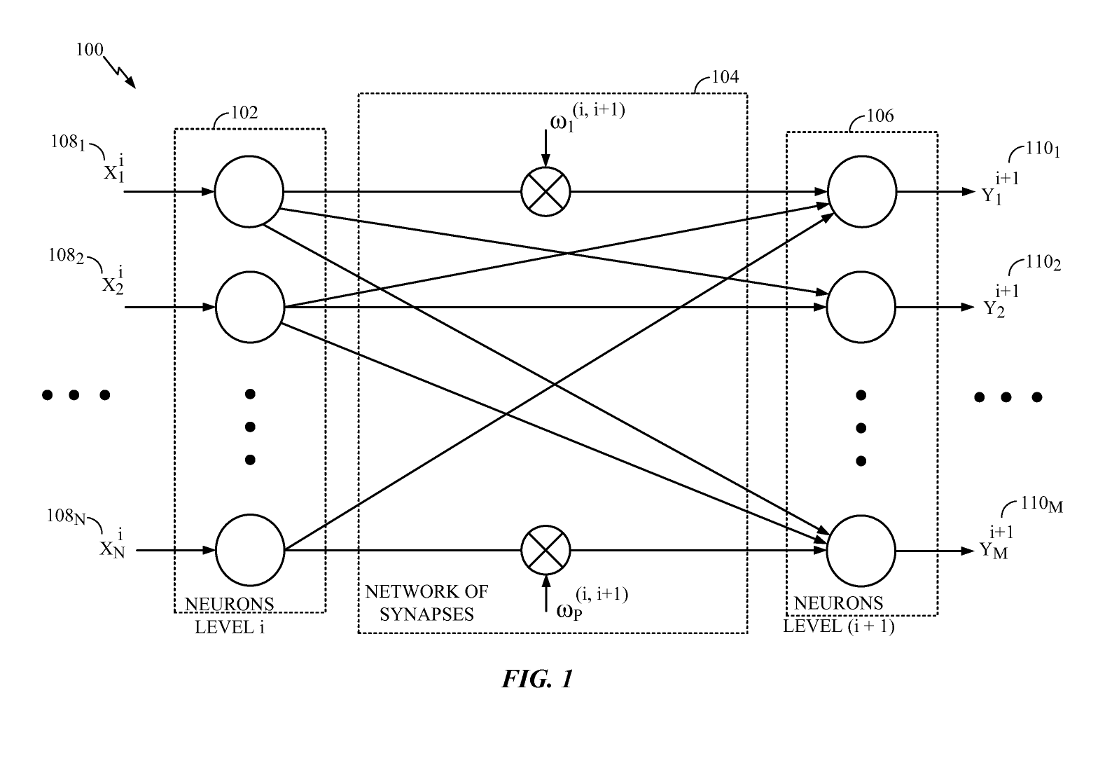

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

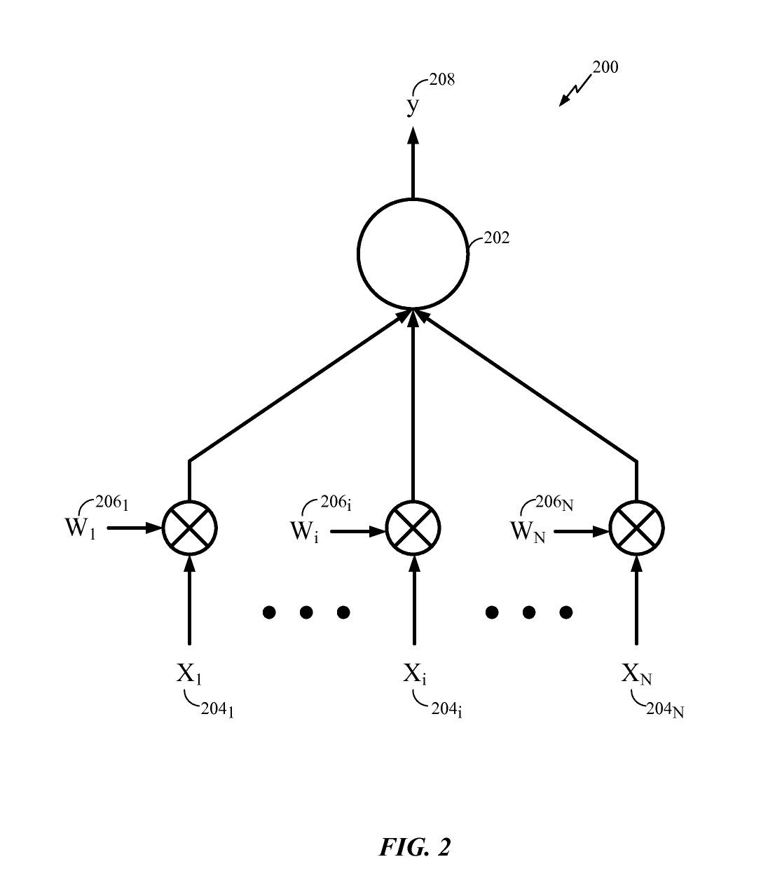

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not use plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , t > 0 \\ {a}_{-} {e}^{t / {k}_{-}} , t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

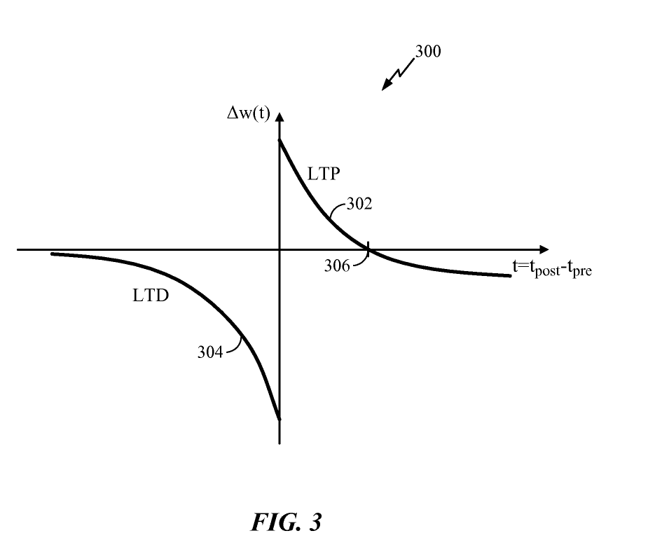

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage Vₚₑₐₖ . For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

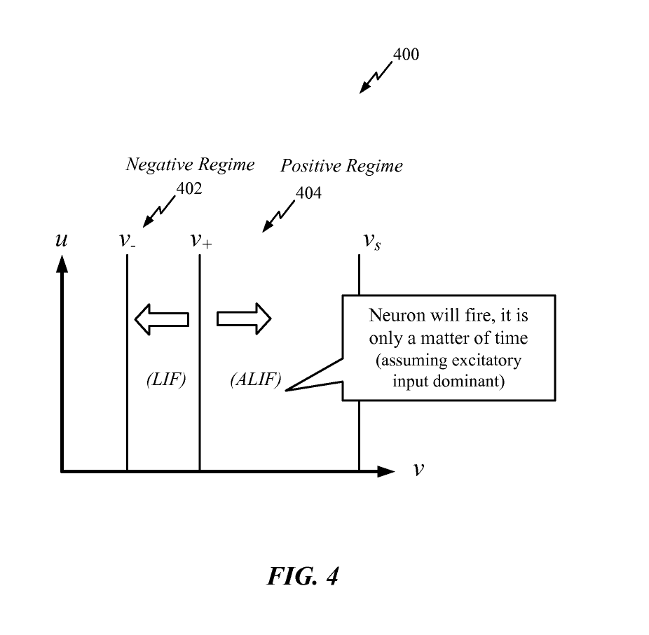

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{p} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊ₓ) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value vₛ. Subsequently, the state may be reset at a reset event (which may be one and the same as the spike event):

v=\hat{v} (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily utilize iterative methods or Numerical methods. An event-based implementation is also possible at a limited time resolution in a step-based simulator by only updating the model if an event occurs at or between steps or by “step-event” update.

### Invariant Object Representation of Images Using Spiking Neural Networks

Aspects of the present disclosure are directed to invariant object representation of images in a spiking neural network.

A desirable property of object representation in a machine learning or computer vision system is invariance. Typical examples of computer vision systems include image classifiers and image recognition systems. The general function of such systems is to recognize or classify different objects irrespective of the specific spatial configuration in which they are presented to the system. For example, a system that has been trained to recognize human faces should be able to reliably detect faces from various angles, at various distances and when presented at different locations within the visual frame.

Neural networks may perform machine learning and may recognize objects. Specifically, spiking neural networks may be used to recognize objects. These networks may be characterized by one or more feature extraction layers followed by a learning layer. Nodes in each layer (e.g., neurons) may encode features in the form of a temporal spike pattern, for example. Common metrics used to decode the features include spike rate and inter-spike intervals.

These networks suffer from being place-codes (i.e., specific configurations of the same object result in specific subsets of neurons spiking) Thus, spiking patterns sent up to the learning layer may not be able to distinguish between different configurations of the same object.

Standard techniques to achieve rotational, scale and shift invariance involve different methods of re-indexing the outputs of the feature extraction layers. In order to use such a scheme for rotation, the center of the object of interest as well as the extent of rotation is derived. In addition, a re-indexing matrix is maintained. Therefore, standard techniques do not scale well to large systems with memory constraints.

Aspects of the present disclosure are directed to an invariant transform of incoming images. The transform layer is designed to produce similar outputs irrespective of the specific scale, position or orientation of the object. This allows the learning layer to remain agnostic to the specific configuration of the object and hence allows it to be simultaneously scale, rotation and shift invariant.

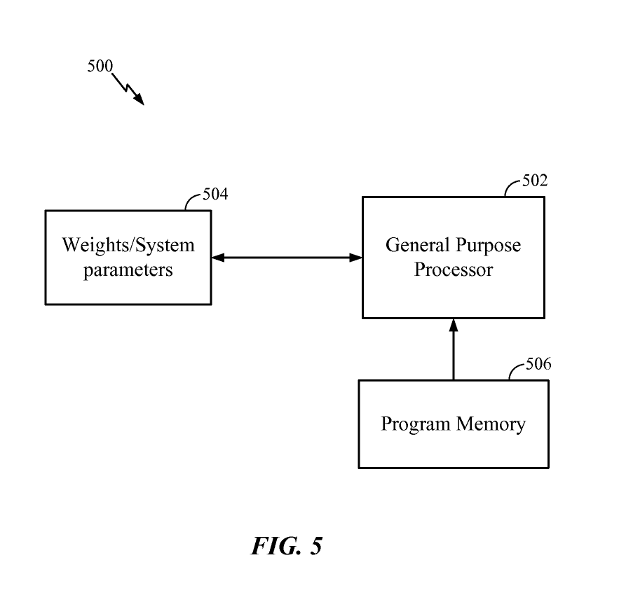

FIG. 5 illustrates an example implementation 500 of the aforementioned invariant object representation of images using a general-purpose processor 502 in accordance with certain aspects of the present disclosure. Variables (neural signals), synaptic weights, system parameters associated with a computational network (neural network), delays, frequency bin information, spike latency information, and histogram information may be stored in a memory block 504, while instructions executed at the general-purpose processor 502 may be loaded from a program memory 506. In an aspect of the present disclosure, the instructions loaded into the general-purpose processor 502 may comprise code for representing an object by a spike sequence, determining a reference feature of the object representation, and/or transforming the object representation to a canonical form based on the reference feature.

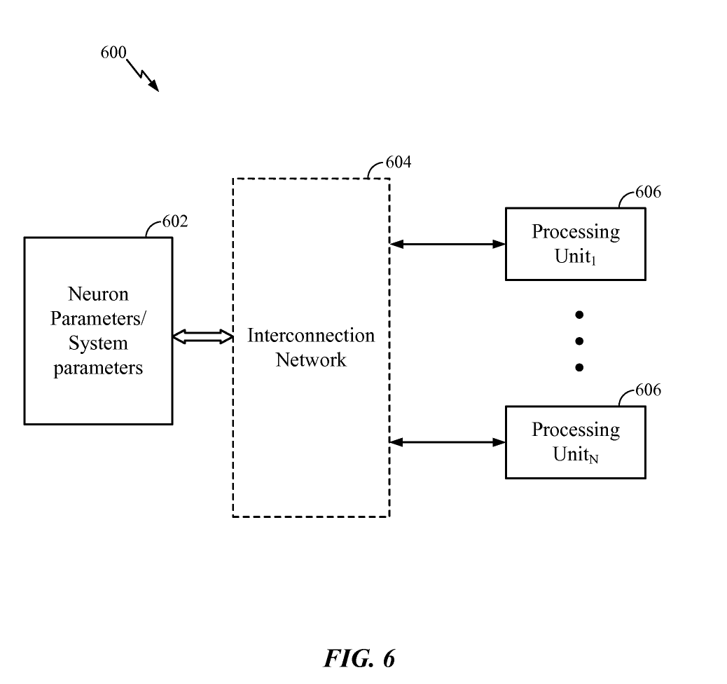

FIG. 6 illustrates an example implementation 600 of the aforementioned invariant object representation of images where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, frequency bin information, and histogram information, may be stored in the memory 602, and may be loaded from the memory 602 via connection(s) of the interconnection network 604 into each processing unit (neural processor) 606. In an aspect of the present disclosure, the processing unit 606 may be configured to represent an object by a spike sequence, determine a reference feature of the object representation, and/or transform the object representation to a canonical form based on the reference feature.

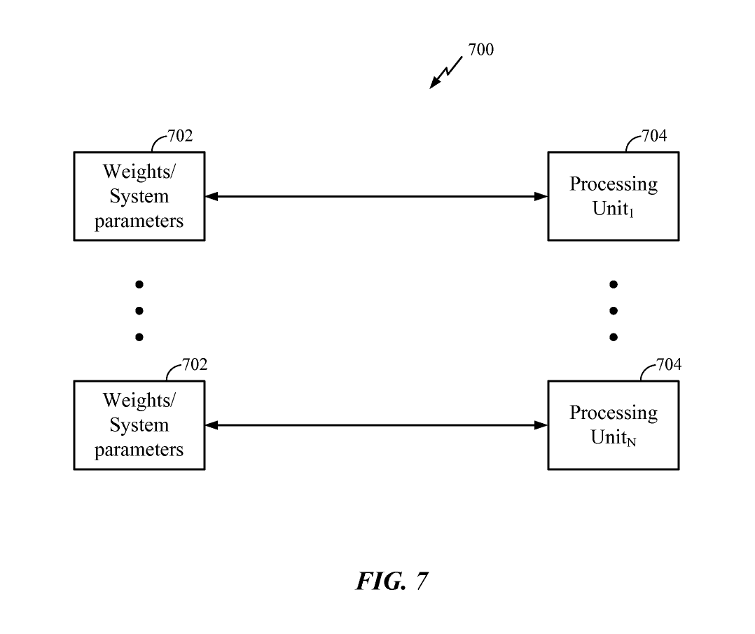

FIG. 7 illustrates an example implementation 700 of the aforementioned invariant object representation of images. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, frequency bin information, and histogram information. In an aspect of the present disclosure, the processing unit 704 may be configured to represent an object by a spike sequence, determine a reference feature of the object representation, and/or transform the object representation to a canonical form based on the reference feature.

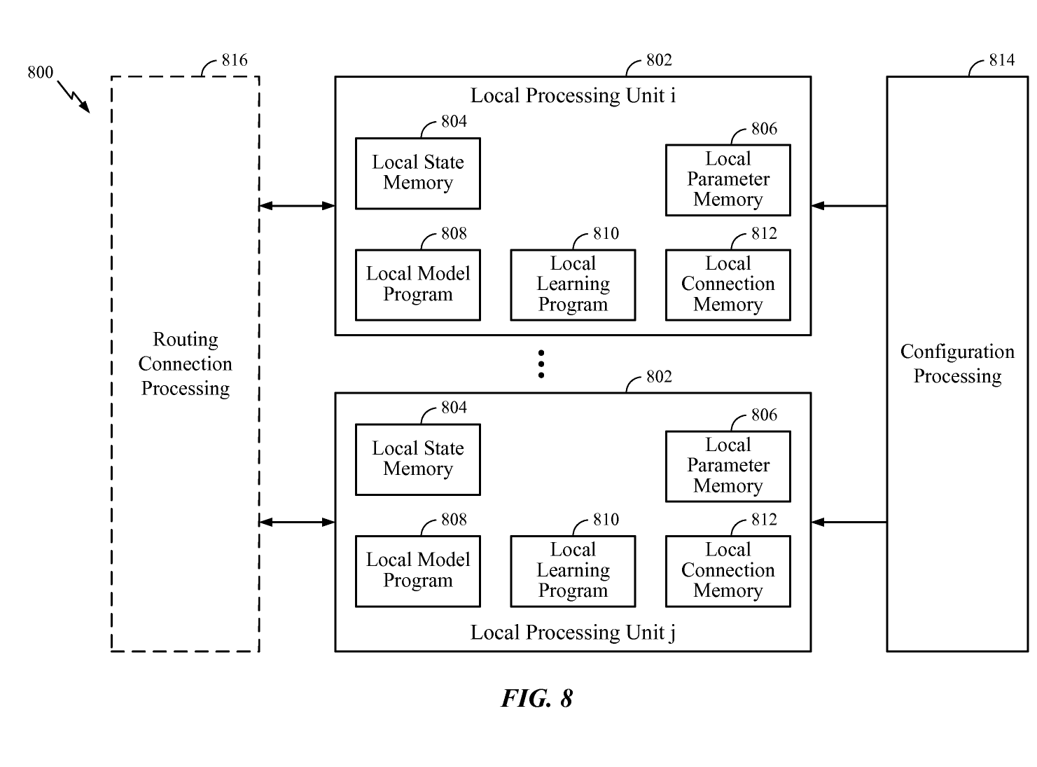

FIG. 8 illustrates an example implementation of a neural network 800 in accordance with certain aspects of the present disclosure. As illustrated in FIG. 8, the neural network 800 may have multiple local processing units 802 that may perform various operations of methods described herein. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processor unit 814 for providing configurations for local memories of the local processing unit, and with a routing unit 816 that provide routing between the local processing units 802.

In one configuration, a neuron model is configured for representing an object by a spike sequence, determining a reference feature of the object representation, and/or transforming the object representation to a canonical form based on the reference feature. The neuron model includes a representing means, determining means and transforming means. In one aspect, the detecting means, determining means, and/or transforming means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

In another configuration, a neuron model is configured for counting spikes, and/or for generating a histogram. The neuron model includes a counting means, and generating means. In one aspect, the counting means and/or generating means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and develop the one or more functional features towards the desired functional features as the determined parameters are further adapted, tuned and updated.

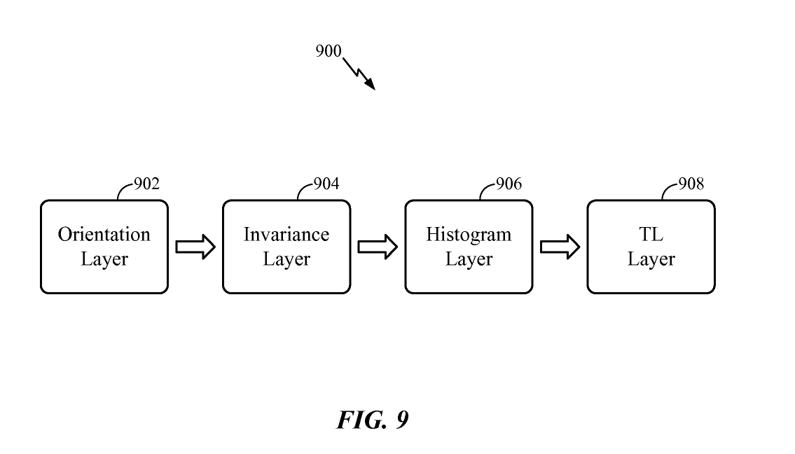

FIG. 9 is a block diagram illustrating an exemplary network structure 900 for invariant object representation in accordance with aspects of the present disclosure. Referring to FIG. 9, the network structure 900 may include an orientation layer 902, an invariance layer 904, a histogram layer 906 and a temporal learning layer 908.

The orientation layer 902 may include one or more cells or neurons and may be used to determine a major axis of alignment or a reference orientation of an object under consideration. The invariance layer 904 performs a set of computations that may map an object to a canonical representation irrespective of its scale, position in a spatial field and degree of rotation. In some aspects, the invariance layer 904 receives feedback regarding the major axis of alignment and may be used to correct the object representation, for example, by encoding an invariant orientation for a pixel or group of pixels comprising the object representation. The histogram layer 906 may be used to construct a histogram of orientations by counting spikes associated with a latency encoded representation of an object. The temporal learning layer 908 may be trained to recognize the histogram of orientations in an image with respect to its major axis. The output of the histogram layer 906 may be substantially identical for various configurations of an incoming image. As such, the temporal learning layer 908 may be a conventional learning layer or any other learning layer.

By using techniques such as edge filters, for example, a local orientation at specified locations can be calculated. To achieve invariance, it may suffice that local orientations measured relative to any axis defined on the object remain a constant when the object is transformed through an in-plane rotation. This is a very general condition that may be true for all rigid objects.

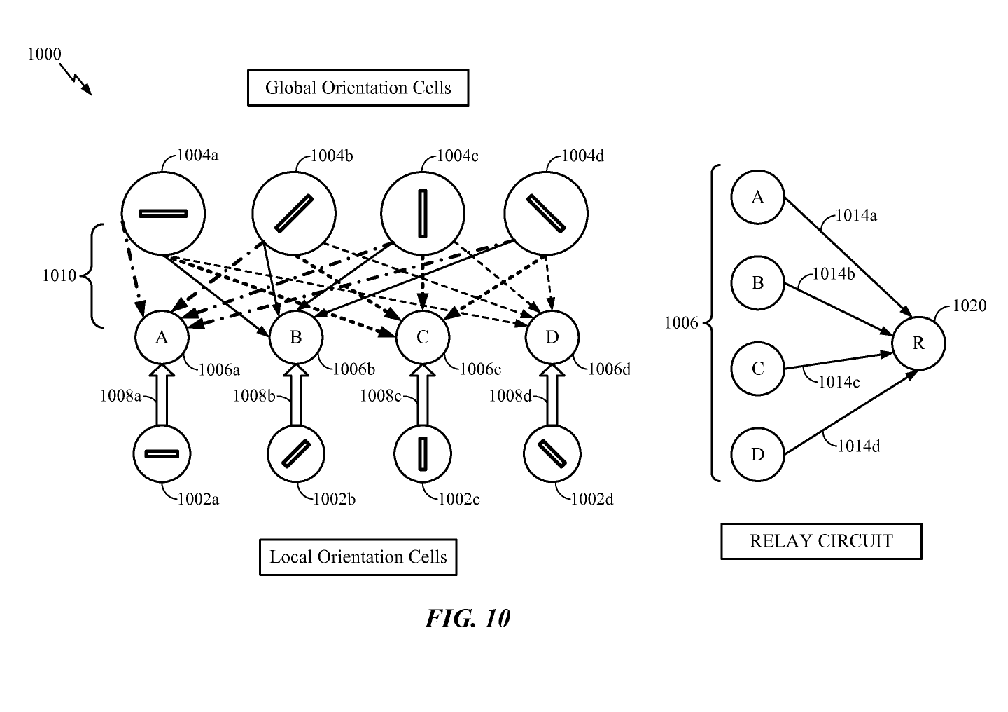

FIG. 10 is a block diagram illustrating exemplary orientation layer circuitry 1000 of a spiking neural network for providing invariant object representation in accordance with aspects of the present disclosure. The orientation layer circuitry 1000 includes local orientation cells 1002a, 1002b, 1002c, and 1002d (may also be collectively referred to as local orientation cells 1002), global orientation cells 1004a, 1004b, 1004c, and 1004d (may also be collectively referred to as global orientation cells 1004) and relay cells 1006a (A), 1006b (B), 1006c (C), and 1006d (D) (may also be collectively referred to as relay cells 1006). Each of the aforementioned cells may, in some aspects, comprise a neuron.

For ease of illustration, the orientation layer circuitry 1000 is shown with four local orientation cells 1002, four global orientation cells 1004 and four relay cells 1006. However, this is merely exemplary and any number of such cells or neurons may alternatively be used. In addition, the orientation layer circuitry 1000 may be provided, for example, at each grid location (e.g., a pixel) of an object representation system. In some aspects, the orientation layer circuitry 1000 may be provided for each N grid locations to enable image sub-sampling.

The local orientation cells 1002 are coupled to the global orientation cells 1004 via a network of synapses (not shown). The local orientation cells 1002 may be configured to detect the presence of an object at a grid location. A grid location may, for example be a pixel or a group of pixels or a predefined region or area of the object representation system. In some aspects, the object may be represented as a spike or sequence of spikes. For example, a spike may be generated based on the presence of an objects at a grid location (e.g., pixel) of a display.

Each of the local orientation cells 1002 may be configured to detect presence of a local angle or orientation of an object within a spatial field of view for the particular local orientation cell (1002a, 1002b, 1002c, or 1002d). For example, local orientation cell 1002a may detect the presence of a 0° local orientation for an object within its spatial field of view. Similarly, the local orientation cell 1002b may detect a 45° local orientation, the local orientation cell 1002c may detect the 90° local orientation, and the local orientation cell 1002d may detect the 135° local orientation.

The local orientation cells 1002 may supply information regarding the detected local angle or orientation of the object to a corresponding global orientation cell 1004. The global orientation cells 1004 pool the outputs from multiple sets of local orientation cells 1002 and may be used to identify a reference feature. For example, in some aspects, the reference feature may comprise a major axis of alignment for an object.

In some aspects, the local orientation cells 1002 and the global orientation cells 1004 may have strong lateral inhibition within a set. That is, only one local orientation cell 1002 (i.e., one of 1002a, 1002b, 1002c or 1002d) and one global orientation cell 1004 (i.e., one of 1004a, 1004b, 1004c or 1004d) may be active for each pixel at a particular time. When an object is presented, at each grid location, a single local orientation cell 1002 may spike in response to edge orientation at that location. When an edge is not present, a local orientation cell 1002 may not spike.

Local orientation cells 1002 of a particular orientation project to a global orientation cell 1004 of the same orientation. The spike time of the global orientation cell 1004 may depend, for example, on the number of incoming spikes. In one exemplary aspect, the spike time may depend on whether the number of incoming spikes is greater than a certain threshold (e.g., the threshold may correspond to a voltage gap between resting and sub-threshold potential in the ALIF model of a neuron). In some aspects, the greater the number of incoming spikes, the shorter the spike time of the global orientation cells (neurons) 1004. Global orientation cells 1004 of different types (e.g., 1004a, 1004b, 1004c, and 1004d) may receive projections from local orientation cells 1002 present over the same spatial region. Thus, a global orientation cell 1004 whose orientation is closest to the reference orientation (e.g., dominant orientation) present in its field of view may spike first and in the process, inhibits global orientation cells 1004 of other types. For example, if global orientation cell 1004b is closest to the reference orientation present in its field of view, the global orientation cell 1004b may spike first and thus inhibit global orientation cells (1004a, 1004c, and 1004d). Accordingly, the orientation of this global orientation cell 1004 may serve as a reference orientation/feature.

The relay cells 1006 respectively receive an input from a local orientation cell 1002 via a synapse (1008a, 1008b, 1008c, 1008d). In addition, the relay cells 1006 each receive an input from all of the global orientation cells 1004 via synapses 1010. As such, the relay cells 1006 may receive orientation information from the global orientation cells 1004 and the local orientation cells 1002. Based on the received information, the relay cells 1006 may signal the presence of any orientation (e.g., 0°, 45°, 90° or 135°). For example, relay cell A 1006a may signal 0°, relay cell B (1006b) may signal the presence of 45°, relay cell C 1006c may signal 90°, and relay cell D (1006d) may signal the presence of 135°. Based on the received information, in some aspects, relay cells 1006 may signal the measure of relative orientation between the orientation determined by the local orientation cell 1002 and the global orientation cell 1004. For example, if a 90° local orientation cell (1002c) and 45° global orientation cell (1004b) spike, the relay cell may signal 90°−45°=45°.

In some aspects, the global orientation cells 1004, having identified the major axis of orientation of the object based on the pooled output of the local orientation cells 1002, may modulate the resting potential of the relay cells 1006 before a spike from the local orientation cells 1002 arrives. In this way, the relay cells 1006 may transform the object representation to a canonical form.

The relay cells 1006 in turn project to a readout neuron (R) 1020 via synapses 1014a, 1014b, 1014c, and 1014d (may be collectively referred to as synapses 1014). The relay cells 1006 and readout neuron 1020 may comprise a relay circuit of the orientation layer circuitry 1000, which may be configured to function in a manner similar to a multiplexer.

The readout neuron 1020 may encode the orientation of a grid location/field of view of a local orientation cell 1002. In some aspects, the readout neurons 1020 may encode the orientation according to spike delay or latency. For example, the spike latency may be measured from a time of presentation of the image at a particular grid/location (e.g., pixel) until received via the relay cell. In some aspects, the spike latency may be measured according to an inter spike interval (ISI) (i.e., time from presentation of an image until spiking.) In one example, a spike latency of 1 s may refer to an orientation of 30° whereas an spike latency of 2 s may refer to an orientation of 60°.

In addition, the readout neurons 1020 may act as mirror neurons. That is, the readout neurons may spike with the same delay as its presynaptic predecessor. For example, if a relay cell 1006 spiked with a latency of 1 s, the readout neuron 1020 may also spike with a 1 s delay.

Accordingly, local orientation cells 1002, global orientation cells 1004, relay cells 1006 and a histogram layer (e.g., 906) may be placed at pre-specified locations of an image. For example, a full image may be divided into 4×4 such regions, having 16 locations (global locations). Each location may be divided into many grid locations (e.g., pixels). At each grid location, a set of local orientation cells and relay cells may be provided. The global orientation cells may pool from the local orientation cells included at each of the grid location of a particular global location.

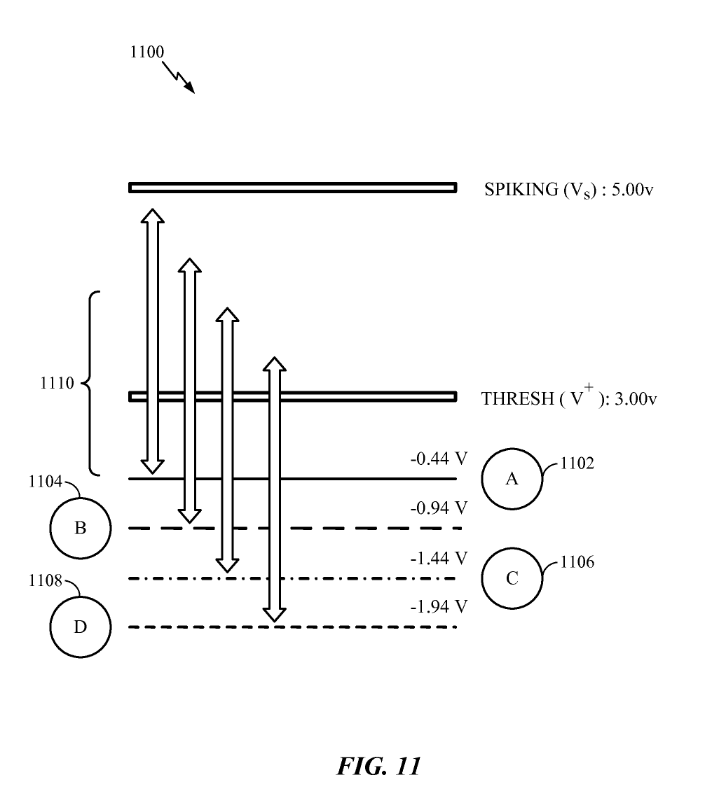

FIG. 11 is a diagram 1100 illustrating an exemplary configuration of relay cells 1006 in accordance with aspects of the present disclosure. In this exemplary configuration, the resting potential of relay cells 1006 is shown at 1102 (A −0.44V), 1104 (B −0.94V), 1106 (C −1.44V) and 1108 (D −1.94V). In contrast, the resting potential for the local orientation cells 1002 and global orientation cells 1004 is 0V. The spiking voltage for the relay cells 1006 may be 5V and the threshold voltage may be 3V. The double arrows 1110 represent the state change in relay cells 1006 upon receiving a spike at a presynaptic end.

In some aspects, the resting potentials for the relay cells 1006 may correspond to a spike latency which may be, for example, measured from the time of presentation of the image at a particular grid location. That is, because different resting potentials may cause a neuron to end up at different voltage levels of the ALIF region on receiving an incoming spike, the different resting potentials may correspond to spiking of neuron with different spike latencies. For example, an spike latency of 0.09 s may represent 0°, a spike latency of 0.21 s may represent 45°, a spike latency of 0.34 s may represent 90° and a spike latency of 0.49 s may represent 135°. As such, relay cells 1006 may be configured to encode an object representation (e.g., orientation) in its latency of firing.

The global orientation cells 1004 may modulate the resting potential of the relay cells based on the determined reference feature (e.g., major axis of orientation). Table 1 lists exemplary modulations that each global orientation cell (1004) may apply to a relay cell (1006). In essence, each synapse (1010) from global orientation cells (1004) to relay cells (1006) may act either as an excitatory synapse or inhibitory synapse, and the strength of inhibition (or excitation) may be encoded in a weight of the synaptic connection.

TABLE 1

Global Orientation

| | | 0° | 45° | 90° | 135° |
|---|---|---|---|---|---|
| Relay | A | 0 | −1.5 | −1.0 | −0.5 |
| | B | 0 | +0.5 | −1.0 | −0.5 |
| | C | 0 | +0.5 | +1.0 | −0.5 |
| | D | 0 | +0.5 | +1.0 | +1.5 |

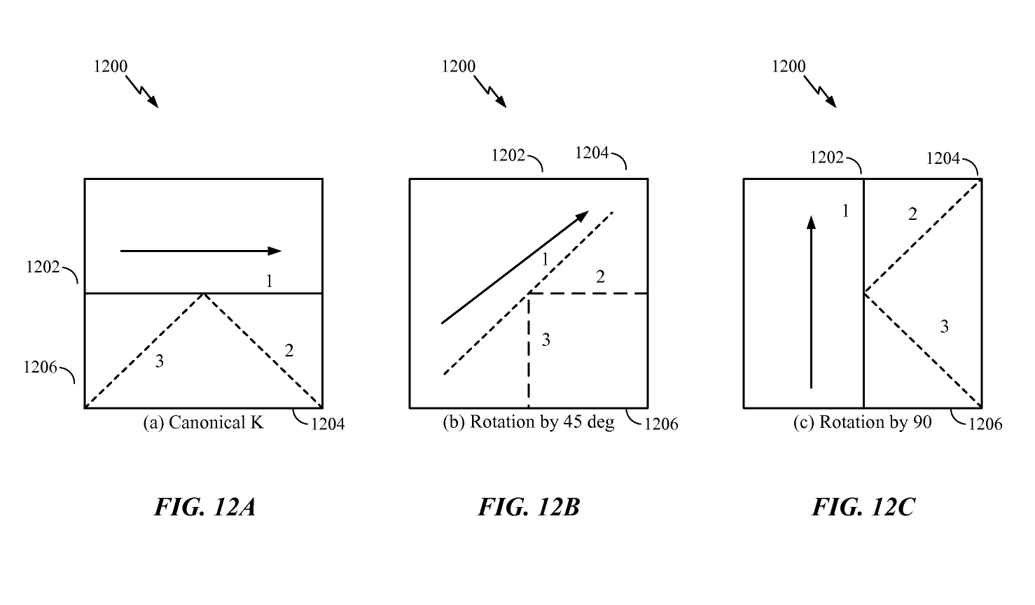

FIGS. 12A-C illustrate orientations of an object in accordance with aspects of the present disclosure. As shown in FIGS. 12A-C, an object, letter ‘K’ is shown in different orientations. FIG. 12A shows an object 1200, which may represent the canonical K. The object 1200 may be divided into 3 segments, segment 1 (1202), segment 2 (1204) and segment 3 (1206). In this example, angles may be measured from the x axis in a counter-clockwise manner. As such, the axis of letter K may be aligned with the x-axis (see segment 1 (1202)). In FIG. 12B, the object 1210 (letter K) is rotated by 45°. Thus, segment 1 (1202), segment 2 (1204), and segment 3 (1206) are each rotated 45°. Because 45° is active as the reference orientation of K, the global orientation cell 1004, which is active for all the segments, is 45°. In FIG. 12C, the object 1200 (letter K) is rotated by 90°. Accordingly, segment 1 (1202), segment 2 (1204), and segment 3 (1206) are each rotated by 90°.

Each synapse has an associated delay. Considering the example of FIG. 12B, the delay between global orientation cells (e.g., 1004) and relay cells (e.g., 1006), for example may be 0.5 s, whereas the delay between local orientation cells (e.g., 1002) and relay cells (e.g., 1006) may be 1 s. For example, along segment 1 (1202), the 45° local orientation cells 1002 may emit a spike at t=1 s which will be received by relay cell B (1006b). As such, in some aspects, a spike from a global orientation cell (e.g., 1004) may reach a relay cell (e.g., 1006) before a spike from a local orientation cell (e.g., 1002).

As indicated above, in the exemplary diagram of FIG. 12B, the reference orientation of the letter K is 45°. As such, the global orientation cell corresponding to 45° is active. Referring to FIG. 11, the resting potential of relay cell B is −0.94V. From Table 1, the modulation effected by the 45° global orientation cell (1004b) is +0.5V. Thus, at t=0.5 s (the delay between the global orientation cells and relay cells), the resting potential would be −0.44V (−0.94V+0.5V). A spike arriving at is from a local orientation cell (1002) may cause the relay cell B (1006b) to fire with a spike latency corresponding to a resting potential of −0.44V (corresponding to relay cell (A)), which in turn corresponds to the 0° orientation. Thus, by encoding timing information via the cell and/or synapse parameters, operation without the use of a clock may be realized as local computations may be performed instead of global computations.

Returning to the example of FIG. 12B, because the reference orientation is 45°, the relay cells (e.g., 1006b) may transform the orientations as detected by the local orientation cells (e.g., 1004b) with respect to this reference orientation. In some aspects, this transformation may be effected by modulating the resting potentials of the relay cells (e.g., 1006) via the global orientation cells (1004).

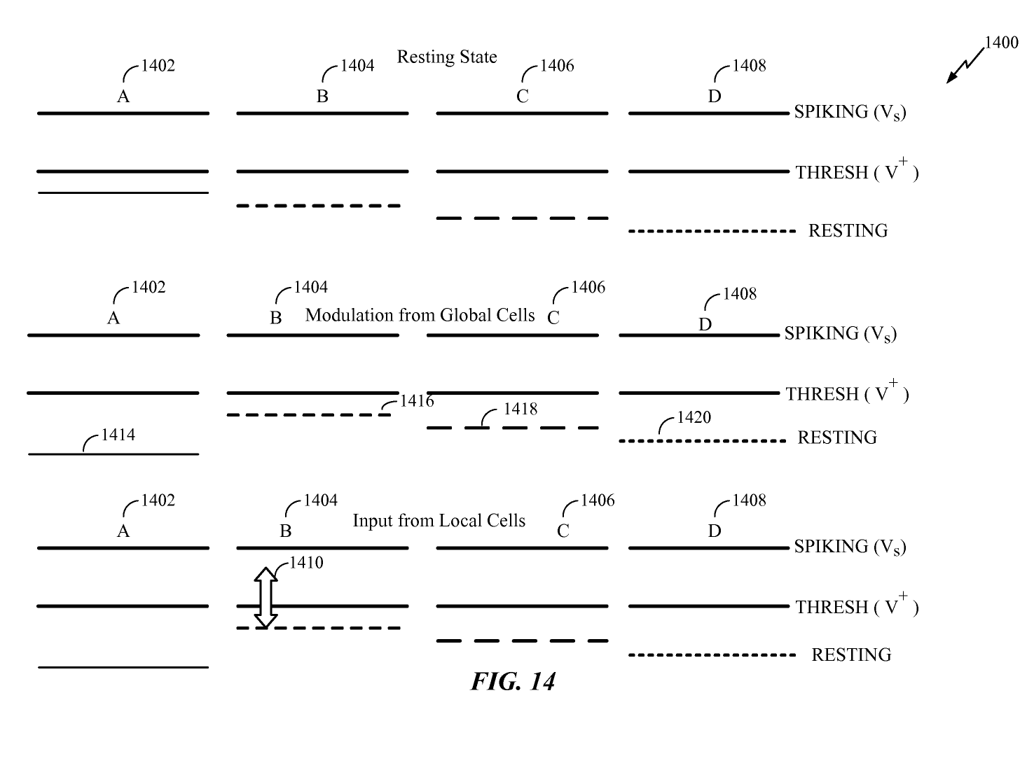

FIG. 14 is an exemplary diagram 1400 illustrating modulated potential of relay cells in accordance with aspects of the present disclosure. The potential of the relay cells (A, B, C, and D) may be provided at an initial state (e.g., resting state). In the initial state, each of the relay cells may be at a resting potential (e.g., as shown in FIG. 11). The global orientation cells (e.g., 1004) may modulate the resting potential of the relay cells. For example, the resting potential of relay cell A (1414) may be decreased, while the resting potentials (1416, 1418, 1420, respectively) of relay cells B, C, and D may be increased.

In some aspects, the resting potential of the relay cells may be modulated by local orientation cells. For example, as shown in FIG. 14, relay cell B may be affected by a spike (1410) from a 45° local cell, which in turn sends relay cell B into the ALIF region. The relay cell B may spike with a time delay based on the orientation of the local orientation cell and the reference orientation. For example, relay cell B may spike at time delay based on a difference between the local orientation and the reference orientation (e.g., local orientation cell orientation (45°)−reference orientation (45°)=0°, which may correspond, for example to a latency of 0.09 s (as discussed above).

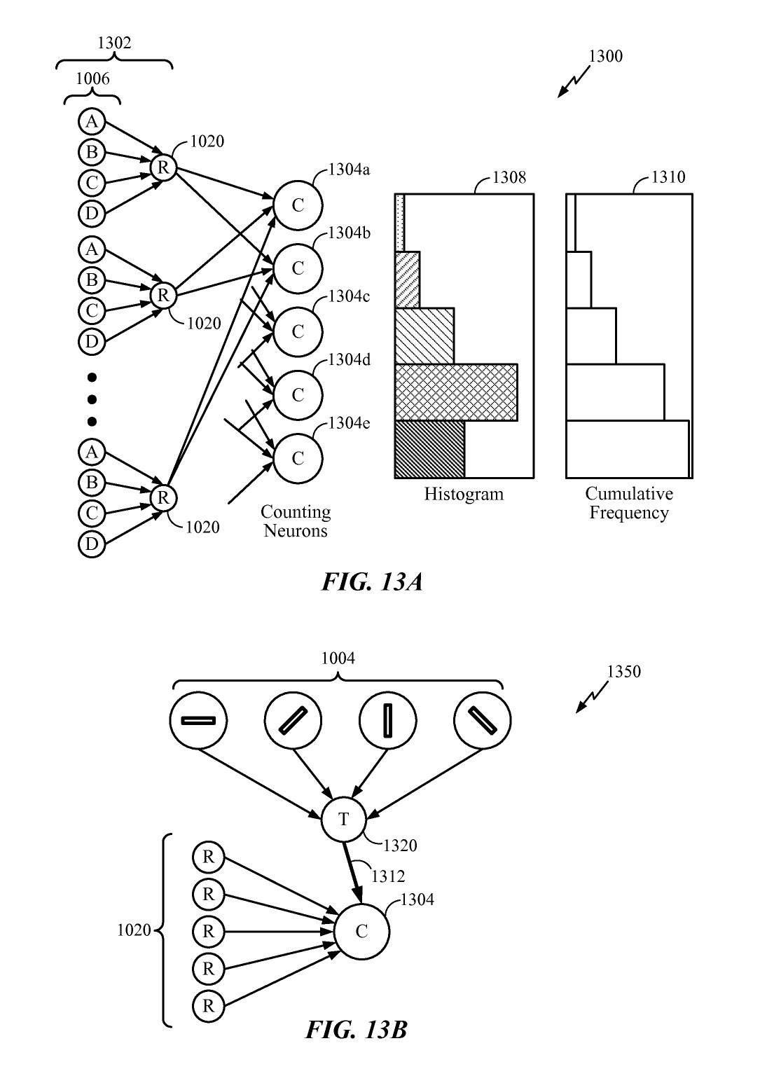

FIGS. 13A-B are diagrams 1300, 1350 illustrating exemplary histogram layers in accordance with aspects of the present disclosure. Referring to diagram 1300 of FIG. 13A, the histogram layer may include relay circuits 1302, each comprising a set of relay cells (e.g., 1006) and a readout neuron (R) (e.g., 1020). The histogram layer also includes counting neurons (C) 1304a, 1304b, 1304c, 1304d, 1304e (which may be collectively referred to as counting neurons (C) 1304).

As shown in the diagram 1350 of FIG. 13B, each of the counting neurons (C) 1304 are coupled to each of the readout neurons (R) (e.g., 1020) and a trigger neuron (T) 1320. The counting neurons (C) 1304 detect the number of inputs at a given spike latency (orientation is encoded in the latency of firing of readout neuron (R) (e.g., 1020)). Trigger neurons (T) 1320 may modulate the membrane potential of a counting neuron (C) 1304 to make it most excitable at a time when spikes corresponding to a particular latency may be expected. For example, a counting neuron (C) 1304 for counting orientations of 45° may be most excitable at a spike latency of 0.21 s, whereas a counting neuron (C) 1304 responsible for 90° may be most excitable at a spike latency 0.34 s.

A trigger neuron (T) 1320 may be provided for each counting neuron (C) 1304. The trigger neuron T 1320 receives inputs from global orientation neurons 1004. In some aspects, the trigger neuron (T) 1320 may be configured with an excitatory synapse 1312 to the counting neuron (C) 1304. In some aspects, each trigger neuron (T) 1320 may act as a timer. Firing of a global orientation cell 1004 may act as a reference time point for the trigger neuron (T). Upon receiving an input spike from a global orientation cell 1004, the trigger neuron (T) 1320 may enter the ALIF region and the parameters (Tau+) may be so configured such that the trigger neuron (T) 1320 spikes at a timing to activate the corresponding counting neuron (C). In this way, spiking of a trigger neuron (T) 1320 may activate the counting neuron (C) 1304 to initiate a count. In some aspects, the counting neuron (C) 1304 may ignore all of its inputs prior to spiking of its corresponding trigger neuron (T) 1320. After a trigger neuron (T) 1320 spikes, the counting neuron (C) 1304 may acts as a counter. Each counting neuron (C) 1304 may represent a bin of a histogram. Accordingly, as each of the counting neurons (C) 1304 count, they may compute a histogram of orientations 1308. In some aspects, the counting neuron (C) 1304 may compute a cumulative histogram of orientations 1310.

In one exemplary aspect, the counting neurons (C) may be configured to count in a cumulative frequency mode. In the cumulative frequency mode, the counting neuron (C) may ignore all inputs received before receiving a spike from the trigger neuron (T). In one example, spike times (0.09 s, 0.21 s, 0.34 s, 0.49 s) may respectively correspond to 0°, 45°, 90°, and 135° orientations. In this example, a counting neuron (C) may be provided for each spike time. As such, a counting neuron for 0.09 s may be activated at a time corresponding to arrival of spikes with a delay of 0.09 s and thus may count all spikes arriving with or after a delay of 0.09 s (which may be all spikes). Similarly, a counting neuron (C) for 0.21 s may count all the spikes arriving with or after the spikes with a delay of 0.21 s. In this way, a cumulative histogram may be obtained.

In another exemplary aspect, the counting neurons (C) may be configured to count in an actual frequency mode. In the actual frequency mode, the counting neuron (C) may ignore all inputs before receiving a spike from a trigger neuron (T) and spikes before the next set of spikes is expected. For example, a counting neuron (C) corresponding to an orientation of 0° may start counting at a time when spikes with a delay around 0.09 s are expected and may deterministically spike before 0.21 s if there are more than a pre-specified number of spikes. Thus, when spikes with a latency of 0.21 s are arriving—the counting neuron (C) corresponding to the orientation of 0° will not take part in counting. This allows each counting neuron to count the number of spikes between pre-specified delay intervals like (0.09 s-0.21 s), (0.21 s-0.34 s), (0.34 s-0.49 s) and so on.

In one exemplary aspect, the histogram layer may operate as follows. Firing of a global orientation cell (e.g., 1004) may send a trigger neuron (T) 1320 into an anti-leaky-integrate-and-fire (A-LIF) region. As indicated above, the global orientation may have strong lateral inhibition. As such, only one global orientation cell (e.g., 1004) fires at any point in time. The trigger neuron (T) 1320 may be indifferent to which global orientation cell has fired, instead the trigger neuron (T) 1320 may simply use a reference time point.

The anti-leaky-integrate-and-fire (A-LIF) time-constant of a trigger neuron (T) 1320 may determine when it will fire and thus, when a corresponding counting neuron (C) 1304 may be most excitable.

The synaptic weights from relay cells (neurons) (R) (e.g., 1006) to counting neurons (C) 1304 may, in some aspects, be configured such that even if all relay neurons (e.g., 1006) fired at the same latency, none of the counting neurons (C) 1304 may spike or move to the anti-leaky-integrate-and-fire (A-LIF) region and will return back to its resting potential very quickly. Instead, in this aspect, it may be that only when the trigger neuron (T) 1320 has made the counting neuron (C) 1304 excitable that the inputs from relay cells (neurons) (R) (e.g., 1006) may cause spiking of the counting neuron (C) 1304.

In some aspects, the temporal learning layer 908 (referred to in FIG. 9) may be trained to recognize a histogram of orientations 1308 in an image with respect to the major axis of the image.

Scaling may involve a proportionate increase or decrease of all oriented edges in an image. Because scaling preserves a relative orientation of any segment of an object with respect to its major axis, it may not affect the relative distribution of orientations represented in the histogram layer 906. Thus, the temporal learning layer 908 may be agnostic to scale transformations.

Similarly, in a translated image, the relative orientations of edges with respect to the major axis may be unchanged. Thus, the histogram layer 906 output may also be unchanged, and in some aspects, may produce translation invariance in the temporal learning layer 908.

Further, because orientations may be measured and may mean detecting edges at different angles and because detecting edges may involve taking a difference, in some aspects, the absolute values of luminance may also be invariant.

A key concept that allows all the invariance types is that in the histogram of orientations domain, a place code is not used. Hence, an object is identified by its relative orientations.

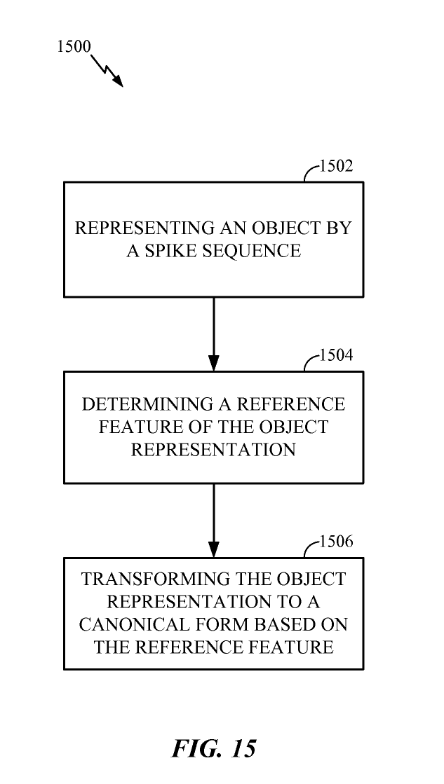

FIG. 15 illustrates a method 1500 for invariantly representing an object using a spiking neural network. In block 1502, the neuron model represents an object by a spike sequence. In block 1504, the neuron model determines a reference feature of the object representation. Furthermore, in block 1506, the neuron model transforms the object representation to a canonical form based on the reference feature.

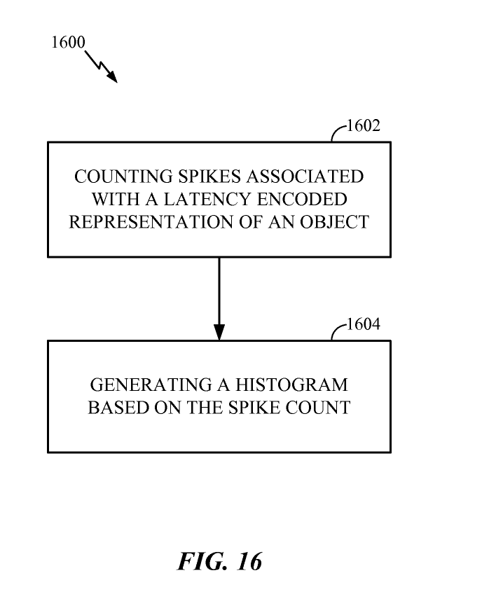

FIG. 16 illustrates a method 1600 for generating a histogram in a spiking neural network. In block 1602, the neuron model counts spikes associated with a latency encoded representation of an object. Furthermore, in block 1604, the neuron model generates a histogram based on the spike count.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for generating a histogram in a spiking neural network comprising:
counting spikes associated with a latency encoded representation of an object; and
generating the histogram based on the spike count.

2. The method of claim 1, in which the histogram comprises a distribution of spikes based on an orientation of the object.

3. The method of claim 1, in which the spikes are counted by a plurality of counting neurons and the histogram includes a number of bins corresponding to each of the plurality of counting neurons.

4. The method of claim 1, in which the histogram comprises a cumulative distribution of the spikes.

5. An apparatus for generating a histogram in a spiking neural network comprising:
a memory; and
at least one processor coupled to the memory, the at least one processor being configured:
to count spikes associated with a latency encoded representation of an object; and
to generate the histogram based on the spike count.

6. The apparatus of claim 5, in which the histogram comprises a distribution of spikes based on an orientation of the object.

7. The apparatus of claim 5, in which the at least one processor is configured to count the spikes using a plurality of counting neurons, and in which the histogram includes a number of bins corresponding to each of the plurality of counting neurons.

8. The apparatus of claim 5, in which the histogram comprises a cumulative distribution of the spikes.

9. An apparatus for generating a histogram in a spiking neural network comprising:
means for counting spikes associated with a latency encoded representation of an object; and
means for generating the histogram based on the spike count.

10. The apparatus of claim 9, in which the histogram comprises a distribution of spikes based on an orientation of the object.

11. The apparatus of claim 9, in which the means for counting spikes counts the spikes using a plurality of counting neurons, and in which the histogram includes a number of bins corresponding to each of the plurality of counting neurons.

12. The apparatus of claim 9, in which the histogram comprises a cumulative distribution of the spikes.

13. A computer program product for generating a histogram in a spiking neural network comprising:
a non-transitory computer readable medium having encoded thereon program code, the program code comprising:
program code to count spikes associated with a latency encoded representation of an object; and
program code to generate the histogram based on the spike count.

14. The computer program product of claim 13, in which the histogram comprises a distribution of spikes based on an orientation of the object.

15. The computer program product of claim 13, further comprising program code to count the spikes using a plurality of counting neurons, and in which the histogram includes a number of bins corresponding to each of the plurality of counting neurons.

16. The computer program product of claim 13, in which the histogram comprises a cumulative distribution of the spikes.
